(19) United States
(12) Patent Application Publication
(10) Pub. No.: US 2024/0078766 A1
(43) Pub. Date: Mar. 7, 2024

(54) DISPLAY SYSTEM AND DISPLAY METHOD

(71) Applicant: HONDA MOTOR CO., LTD., Tokyo (JP)

(72) Inventors: Manabu Shimizu, Wako-shi (JP); Yuji Tsuchiya, Wako-shi (JP)

(21) Appl. No.: 18/451,911

(22) Filed: Aug. 18, 2023

(30) Foreign Application Priority Data
Sep. 1, 2022 (JP) 2022-139219

(51) Int. Cl. G06T 19/00; B60K 35/00; B60R 1/23; G06T 3/40; G06T 7/60; G06T 7/70; G06T 11/00

(52) U.S. Cl. CPC G06T 19/006; B60K 35/00; B60R 1/23; G06T 3/40; G06T 7/60; G06T 7/70; G06T 11/00; G06F 3/0488; G06T 2200/24; G06T 2207/30252

(57) ABSTRACT

A display system includes a location acquiring unit that acquires a current location of an own vehicle, an environment image generating unit that generates a virtual environment image based on a current location of the own vehicle and map information, the virtual environmental image being a virtual image showing a surrounding environment of the own vehicle, a partial video image extracting unit that acquires a real environment video image of a surrounding of the own vehicle and extracts a participant video image, the participant video image being a video image portion of a traffic participant from the real environment video image, and a display control unit that generates and displays on a display device a composite image by inlaying each of the extracted participant video image into the virtual environment image at a corresponding position on the virtual environment image.

### INCORPORATION BY REFERENCE

The present application claims priority under 35 U.S.C. § 119 to Japanese Patent Application No. 2022-139219 filed on Sep. 1, 2022. The content of the application is incorporated herein by reference in its entirety.

### BACKGROUND OF THE INVENTION

### Field of the Invention

The present invention relates to a display system and display method that displays a surrounding environment of an own vehicle.

### Description of the Related Art

In recent years, there is an increasing effort to provide access to sustainable transit systems that also consider people in weak situations among traffic participants. In order to achieve this, commitment to research and development is ongoing, which may further improve safety and convenience of transportation through research and development relating to preventive safety technology.

Japanese Patent Laid-Open No. 2013-200819 discloses an image receiving and displaying device that geometrically converts a video image imaged by using a camera installed outside an own vehicle into a video image when viewed from a predetermined location outside the own vehicle and displays it. In this image receiving and displaying device, an icon replacing an image portion of a predetermined object extracted from the video image is displayed on the video image after the conversion above, or the icon combined with a map image is displayed.

By the way, in preventive safety technology, for safety driving of an own vehicle, it is a challenge to convey the existence of a traffic participant surrounding an own vehicle in a recognizable manner to a driver in providing information through a display device to complement driver's perception.

In this connection, the technology disclosed in Japanese Patent Laid-Open No. 2013-200819 only displays an icon of a traffic participant in a video image showing a surrounding environment or a map image and has limitations on conveying the existence of a traffic participant in a realistic and conspicuous manner to a driver.

In order to solve the problem above, an object of the application is to achieve preventive safety for own vehicle driving by, for conveying information of a surrounding of an own vehicle to a driver through a display device, omitting information unnecessary for driving and simply displaying necessary information while conveying the existence of a traffic participant or the like in a recognizable manner. It consequently contributes to advancement of sustainable transit systems.

### SUMMARY OF THE INVENTION

One aspect of the present invention is a display system including a location acquiring unit that acquires a current location of an own vehicle, an environment image generating unit that generates a virtual environment image based on a current location of the own vehicle and map information, the virtual environment image being a virtual image showing a surrounding environment of the own vehicle, a partial video image extracting unit that acquires a real environment video image of a surrounding of the own vehicle and extracts a participant video image, the participant video image being a video image portion of a traffic participant from the real environment video image, and a display control unit that generates and displays on a display device a composite image by inlaying each of the extracted participant video image into the virtual environment image at a corresponding position on the virtual environment image.

According to another aspect of the present invention, the display control unit highlights a participant video image of the traffic participant who is a pedestrian in the displayed composite image.

According to another aspect of the present invention, further including a vehicle detecting unit that detects, from the real environment video image, a location of a surrounding vehicle that is a vehicle within the surrounding environment and a vehicle attribute including a model, a size, and/or color of the surrounding vehicle, the display control unit generates the composite image by inlaying a virtual vehicle representation, which is a graphic representation according to a vehicle attribute of the surrounding vehicle, at a corresponding position on the virtual environment image as a surrounding vehicle indication for a traffic participant which is a surrounding vehicle.

According to another aspect of the present invention, the display device is a touch panel, and, in response to a user's operation on the display device, the display control device displays the composite image on the display device such that the position designated by the operation is at the center by moving the point of view for the composite image and/or displays the composite image enlarged by a predetermined magnification on the display device.

According to another aspect of the present invention, the vehicle detecting unit determines the presence of a possibility that the surrounding vehicle contacts the own vehicle, and when there is a possibility that the surrounding vehicle contacts the own vehicle, the display control unit highlights the surrounding vehicle indication corresponding to the surrounding vehicle on the composite image.

According to another aspect of the present invention, the display control unit generates a composite image based on the virtual environment image and the participant video image at a current time at predetermined time intervals and displays the composite image at the current time in real time on the display device.

According to another aspect of the present invention, the display device is arranged in front of a pillar on a side having a driver's seat of the own vehicle.

According to another aspect of the present invention, the virtual environment image is an image having a bird's eye view of the surrounding environment including a current location of the own vehicle, and a virtual own-vehicle representation, which is a graphic representation indicating the own vehicle, is overlaid at a position corresponding to the own vehicle on the virtual environment image.

Another aspect of the present invention is a display method executed by a computer included in a display system, the method including the steps of acquiring a current location of an own vehicle, generating a virtual environment image based on a current location of the own vehicle and map information, the virtual environment image being a virtual image showing a surrounding environment of the own vehicle, acquiring a real environment video image of a surrounding of the own vehicle and extracting a participant video image, the participant video image being a video image portion of a traffic participant from the real environment video image, and generating and displaying on a display device a composite image by inlaying each of the extracted participant video image into the virtual environment image at a corresponding position on the virtual environment image.

According to the present invention, in a display system that displays a surrounding environment of an own vehicle, the existence of a traffic participant or the like can be conveyed to the driver in a recognizable and realistic aspect by omitting information unnecessary for driving and simply displaying necessary information.

### BRIEF DESCRIPTION OF THE DRAWINGS

FIG. 1 is a diagram showing an example of a configuration of an own vehicle in which a display system is mounted according to one embodiment of the present invention;

FIG. 2 is a diagram showing an example of a configuration of an interior of the own vehicle;

FIG. 3 is a diagram showing a configuration of a display system according to one embodiment of the present invention;

FIG. 4 is a diagram showing an example of a composite image to be displayed on the display device by the display system;

FIG. 5 is a diagram showing an example of a composite image before a movement of a point of view for describing a movement of the center of a point of view for a composite image by a touch operation;

FIG. 6 is a diagram showing an example of a composite image after a movement of a point of view for describing a movement of the center of a point of view for a composite image by a touch operation;

FIG. 7 is a diagram showing an example of a composite image before a movement of a point of view and enlargement for describing an enlarged display of a composite image by a touch operation;

FIG. 8 is a diagram showing an example of a composite image after a movement of a point of view and enlargement for describing an enlarged display of a composite image by a touch operation; and

FIG. 9 is a flowchart showing a procedure of a display method executed by a processor in a display system.

### DETAILED DESCRIPTION OF THE PREFERRED EMBODIMENTS

Embodiments of the present invention are described below with reference to drawings.

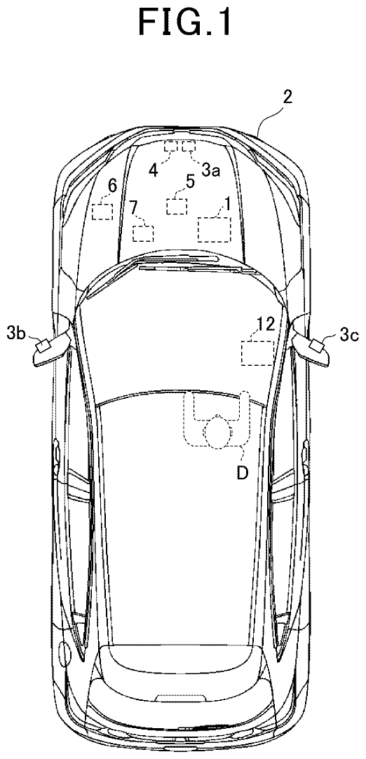

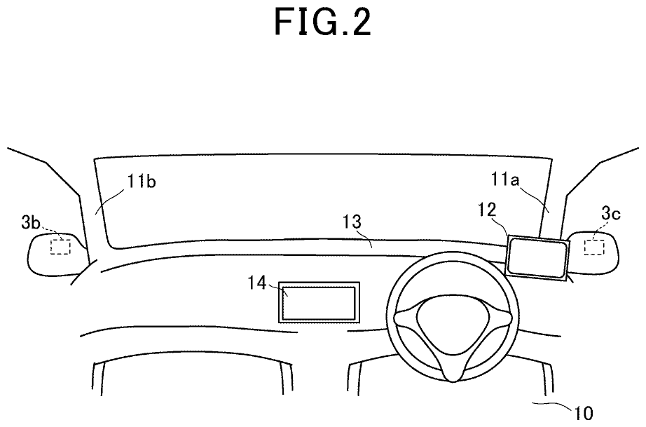

FIG. 1 is a diagram showing an example of a configuration of an own vehicle 2 that is a vehicle in which a display system 1 is mounted according to one embodiment of the present invention. FIG. 2 is a diagram showing an example of a configuration of an interior of the own vehicle 2. The display system 1 is mounted in the own vehicle 2 and displays, on a display device 12, a virtual environment image that is a virtual image of a surrounding environment of the own vehicle 2 (hereinafter, simply also called “surrounding environment”), and conveys presence of a traffic participant within the surrounding environment to a driver D.

A front camera 3a that captures a front part of the own vehicle 2 of the surrounding environment and a left lateral camera 3b and a right lateral camera 3c that capture a right and left lateral parts of the own vehicle 2 are deployed in the own vehicle 2. Hereinafter, the front camera 3a, the left lateral camera 3b and a right lateral camera 3c are also collectively called a camera 3. The front camera 3a is deployed, for example, near a front bumper, and the left lateral camera 3b and the right lateral camera 3c are deployed, for example, on left and right door mirrors. The own vehicle 2 may further include a rear camera (not shown) that captures a surrounding environment in a rear part of the vehicle.

An object detection device 4 that detects an object present in a surrounding environment is further mounted in the own vehicle 2. The object detection device 4 may be, for example, a radar, a sonar, and/or a lidar.

A vehicle monitoring device 5 that collects at least information on a running speed of the own vehicle 2 and information on an operation of a direction indicator lamp (not shown), a GNSS receiver 6 that receives location information on a current location of the own vehicle 2 from a GNSS satellite, and a navigation device 7 that performs routing assistance by using map information are further mounted in in the own vehicle 2.

The display device 12 is arranged in front of a pillar 11a on a side having the driver's seat 10 provided on the right side in the vehicle width direction in the interior of the own vehicle 2. The display device 12 is, for example, a touch panel. It should be noted that, when the driver's seat 10 is provided on the left side in the vehicle width direction, the display device 12 may be provided in front of the pillar 11b on the left side (that is, the side having the driver's seat). Hereinafter, the pillars 11a and 11b are collectively called a pillar 11.

Another display device 14 to be used by the navigation device 7 for displaying map information is provided at the center position in the vehicle width direction of the front instrument panel 13 of the driver's seat 10.

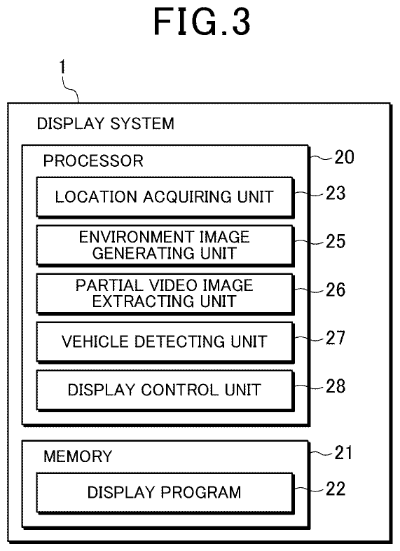

FIG. 3 is a diagram showing a configuration of the display system 1.

The display system 1 has a processor 20 and a memory 21. The memory 21 is implemented by, for example, a volatile and/or nonvolatile semiconductor memory and/or a hard disk device or the like. The processor 20 is, for example, a computer including a CPU and so on. The processor 20 may have a ROM in which a program is written, a RAM for temporarily storing data, and so on. The processor 20 includes, as functional elements or functional units, a location acquiring unit 23, an environment image generating unit 25, a partial video image extracting unit 26, a vehicle detecting unit 27, and a display control unit 28.

These functional elements included in the processor 20 are implemented by execution by the processor 20 being a computer, for example, of a display program 22 saved in the memory 21. It should be noted that the display program 22 can be prestored in an arbitrary computer-readable storage medium. Instead of this, each of all or some of the functional elements included in the processor 20 can be implemented by hardware including one or more electronic circuit components.

The location acquiring unit 23 receives location information through the GNSS receiver 6 and acquires a current location of the own vehicle 2.

The environment image generating unit 25 generates a virtual environment image, which is a virtual image showing a surrounding environment of the own vehicle 2, based on a current location of the own vehicle 2 and map information. The map information can be acquired from, for example, the navigation device 7. According to this embodiment, the virtual environment image generated by the environment image generating unit 25 is a three-dimensional image (3D display image) having a bird's eye view of the surrounding environment, including, for example, the current location of the own vehicle.

The partial video image extracting unit 26 acquires a real environment video image of a surrounding of the own vehicle 2 with the camera 3 and extracts a participant video image, the participant video image being a video image portion of a traffic participant from the acquired real environment video image.

The vehicle detecting unit 27 detects, from the real environment video image, a location of a surrounding vehicle that is a vehicle within a surrounding environment and a vehicle attribute including a model, a size, and/or color of the surrounding vehicle. The size of a surrounding vehicle can be calculated based on, for example, an angle of view of the surrounding vehicle in the real environment video image and a distance to the surrounding vehicle detected by the object detection device 4 by following a conventional technology. Also, the model of a surrounding vehicle can be identified by image matching with template images showing sizes and shapes of models such as trucks, buses, automobiles, motorcycles and so on, prestored in the memory 21 by following a conventional technology, for example.

Also, the vehicle detecting unit 27 determines the presence of possibility that the detected surrounding vehicle contacts the own vehicle 2. For example, the vehicle detecting unit 27 determines the presence of the aforementioned possibility of a contact based on information regarding the speed of a surrounding vehicle, information regarding a lighting state of a direction indicator lamp, information regarding the speed of the own vehicle 2, information regarding an operation on the direction indicator lamp, and/or information regarding a planned running route of the own vehicle 2 in accordance with a conventional technology. Here, the information on a speed of a surrounding vehicle and the information on a lighting state of the direction indicator lamp may be acquired from a real environment video image. The information regarding the speed of the own vehicle 2 and information regarding an operation on the direction indicator lamp may be acquired from the vehicle monitoring device 5. Also, the information regarding a planned running route of the own vehicle 2 may be acquired from the navigation device 7.

The display control unit 28 generates and displays on the display device 12 a composite image by inlaying each of participant video images extracted by the partial video image extracting unit 26 into the virtual environment image generated by the environment image generating unit 25 at a corresponding position on the virtual environment image. For example, the display control unit 28 generates a composite image based on a virtual environment image and a participant video image at a current time at predetermined time intervals and displays the composite image at the current time in real time on the display device 12.

The size of the participant video image to be inlaid to a virtual environment image can be a size acquired by, for example, reducing the real size calculated for a traffic participant therein to a scale of a virtual environment image at a location for inlaying the participant video image by following a conventional technology. Like the size of a surrounding vehicle described above, the real size of a traffic participant can be calculated based on angle of view of the traffic participant in a real environment video image and a distance to the traffic participant detected by the object detection device 4.

The display control unit 28 may further generate a composite image by overlaying a virtual own-vehicle representation, which is a graphic representation of the own vehicle 2 (or graphic representation showing the own vehicle 2), at a corresponding position on a virtual environment image. For example, the virtual own-vehicle representation is a graphic indication that imitates a movement of the own vehicle viewed from the rear, and a composite image may be a so-called chasing view from a point of view following the own vehicle from the rear.

In the display system 1 having the aforementioned configuration, since a surrounding environment of the own vehicle 2 is displayed on the display device 12 as a composite image, the driver D can recognize on the screen of the display device 12 the presence of a pedestrian or the like existing at a blind spot such as behind the pillar 11 when turning at an intersection where many items regarding a traffic condition are to be checked, for example, the driving load can be reduced. Also, a video image of a traffic participant is inlaid as a participant video image of the composite image displayed on the display device 12, the presence of a traffic participant such as a pedestrian can be conveyed to a driver D realistically (that is, in a realistic aspect).

Also, in the display system 1, since a composite image is based on a three-dimensional virtual environment image from a bird's eye view of surroundings of the current location of the own vehicle 2, the driver D can easily grasp a positional relationship between a traffic participant present in the surrounding environment and the own vehicle and a positional relationship between traffic participants, compared to a bird's eye view by which a video image combining a plurality of camera images is easily distorted. Also, by using a virtual environment image, unnecessary information for driving present in the real space can be omitted, and necessary information in the surrounding environment can be simply displayed. Further, in the display system 1, with a participant video image inlaid into a virtual environment image, the existence of a traffic participant and the like that should be considered in driving can be conveyed to a driver in a recognizable and realistic aspect.

Also, by presenting a traffic participant in a participant video image, the driver D can easily correlate between a participant video image and a traffic participant present in the real environment and is facilitated to recognize the traffic participant in the real space. Furthermore, since the virtual environment image can be displayed with unnecessary information omitted other than, for example, a positional dimension of an intersection, a lane, and sidewalks, the driver D can concentrate on necessary information without being confused by the unnecessary information.

Also, in the display system 1, since the display device 12 is arranged at a position of the pillar 11 on the side having the driver's seat 10, for example, the driver D can acquire information from a composite image displayed on the display device 12 with small movement of line of sight.

It should be noted that, in the display system 1, the display control unit 28 may highlight a participant video image of a traffic participant being a pedestrian or a bicycle in a displayed composite image. The highlighting above can be performed by, for example, displaying in a warm color at least a part of a frame line of an outer circumference (that is, boundaries of a virtual environment image) of a participant video image, increasing or changing (blinking, for example) the luminance of the participant video image to be higher than that of its surroundings, increasing a warm tint of the participant video image, or the like.

Thus, in the display system 1, the existence of a pedestrian and a bicycle that can be easily overlooked by the driver D can be conveyed to the driver D more securely and realistically.

Also for a surrounding vehicle being a traffic participant, a composite image can be generated by inlaying a participant video image of the surrounding vehicle into a virtual environment image, in the same manner as described above. However, according to this embodiment, for a traffic participant which is a surrounding vehicle, the display control unit 28 generates a composite image by inlaying a virtual vehicle representation, which is a graphic representation according to a vehicle attribute of the surrounding vehicle, detected by the vehicle detecting unit 27 at a corresponding position on the virtual environment image as a surrounding vehicle indication. For example, if the model indicated by a vehicle attribute is a truck, the display control unit 28 can generate a composite image by inlaying a virtual vehicle representation of the truck prestored in the memory 21 into a virtual environment image by using a color and a size depending on the color and size indicated by the vehicle attribute.

Thus, in the display system 1, since a virtual vehicle representation is used for display of a vehicle with detail information (for example, sense of speed, color, sense of size, model) that can be easily represented by using a graphic representation among traffic participants, the processing load required for generation and output of a composite image to a display device can be reduced.

It should be noted that which of a virtual vehicle representation and a participant video image is to be used to display a surrounding vehicle can be switched by using, for example, a setting button (not shown) or the like that the display control unit 28 displays on the display device 14.

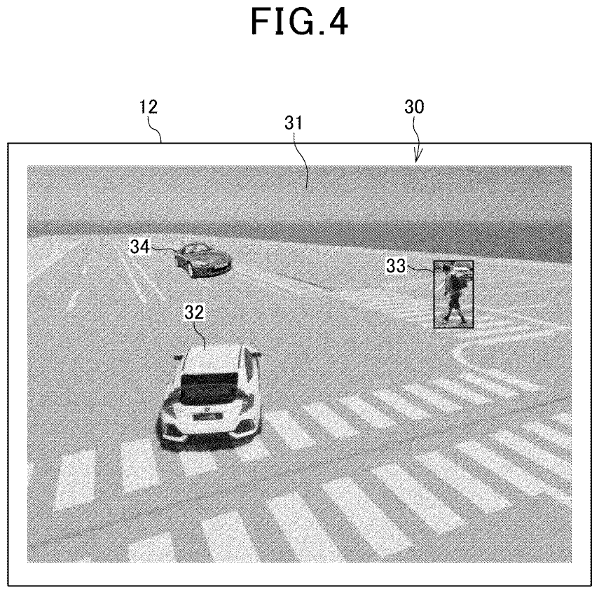

FIG. 4 is a diagram showing an example of a composite image that the display control unit 28 displays on the display device 12. FIG. 4 is a composite image when the own vehicle 2 turns to the right at an intersection. In a composite image 30 displayed on the display device 12, a virtual own-vehicle representation 32 indicating the own vehicle 2, a participant video image 33 indicating a traffic participant who is a pedestrian, and a surrounding vehicle indication 34 of a surrounding vehicle approaching the own vehicle 2 as an oncoming car are displayed in a three-dimensional virtual environment image 31 looking down at a surrounding environment at the current location of the own vehicle 2.

When there is a possibility that a surrounding vehicle contacts the own vehicle, that is, if the vehicle detecting unit 27 determines that there is a possibility that a surrounding vehicle contacts the own vehicle 2, the display control unit 28 may further highlight a surrounding vehicle indication (virtual vehicle representation or participant video image of the surrounding vehicle) on the composite image.

Thus, in the display system 1, the presence of a surrounding vehicle that may possibly contact or collide can be conveyed more securely to the driver D.

Like the aforementioned highlighting of a participant video image of a traffic participant which is a pedestrian, the highlighting above can be performed by, for example, displaying a warm-colored frame line on a surrounding vehicle indication, increasing or changing over time the luminance of a surrounding vehicle indication to be higher than that of its surroundings, increasing a warm-color tint of a surrounding vehicle indication, or the like.

In response to a user's operation on the display device 12 that is a touch panel, the display control unit 28 further displays a composite image on the display device 12 such that the position designated by the operation is at the center by moving the point of view for the composite image and/or displays the composite image enlarged by a predetermined magnification on the display device 12. The user's operation is a touch operation on the display device 12 that is a touch panel, for example. In response to a touch on a part of the displayed composite image, the display control unit 28 displays the composite image on the display device 12 such that the touched position is at the center by moving the point of view for the composite image and/or displays the composite image enlarged by a predetermined magnification on the display device 12.

Thus, in the display system 1, the driver D can freely change the center position and/or the display magnification of the composite image as needed, allowing to grasp the surrounding environment more easily.

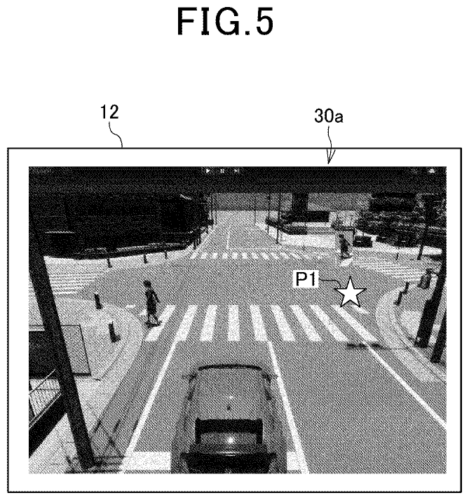

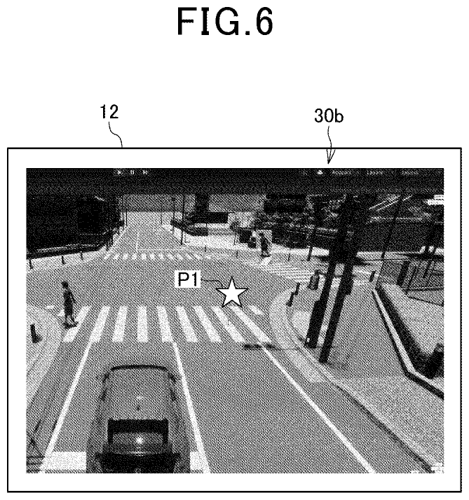

FIGS. 5 and 6 are diagrams showing examples of the movement of a point of view of the displayed composite image by a touch operation on the composite image. On a composite image 30a shown in FIG. 5, when a position P1 as shown in a star shape is tapped, a composite image 30b is displayed resulting from a movement of the point-of-view center position to the point P1, as shown in FIG. 6. It should be noted that the return to the original point-of-view center position can be achieved in response to, for example, a tap on the BACK button (not shown) that the display control unit 28 overlays on the composite image.

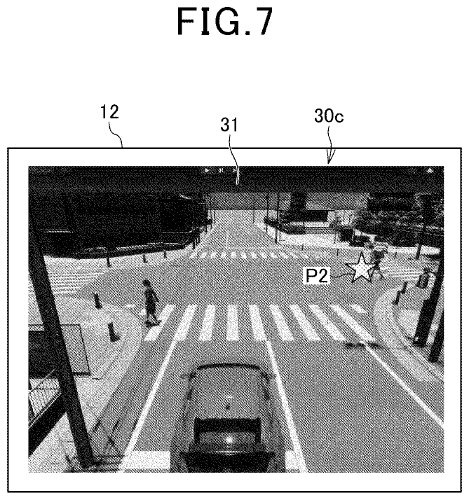

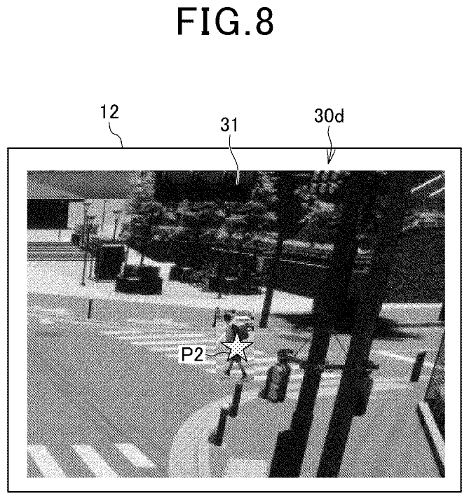

FIGS. 7 and 8 are diagrams showing examples of the enlarged display of the composite image by a touch on the composite image. On the composite image 30c shown in FIG. 7, when a position P2 as shown in a star shape is double-tapped, the composite image 30d is displayed resulting from a movement of the point-of-view center position to the point P2 and an increase of the display magnification as shown in FIG. 8. For example, every time the displayed composite image is double-tapped, the display control unit 28 can repeat the movement of the point-of-view center and the increase of the display magnification. The return to the original point-of-view center position and the original display magnification can be achieved in response to, for example, a tap on the BACK button that the display control unit 28 overlays on the composite image, in the same manner as described above.

It should be noted that a user's operation on the display device 12 may be any arbitrary operation without limiting to a touch operation. For example, the aforementioned operation may be performed by an operation on a switch button (not shown) displayed on the display device 14.

Next, a procedure of operations in the display system 1 is described.

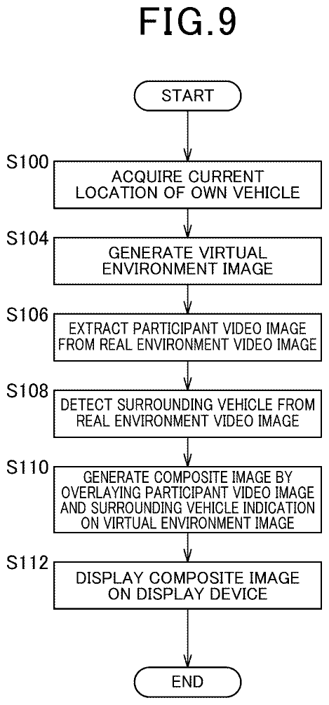

FIG. 9 is a flowchart showing a procedure of processing of a display method for displaying a surrounding environment of the own vehicle 2, which is executed by the processor 20 that is a computer in the display system 1. This processing is repetitively executed.

When the processing starts, the location acquiring unit 23 first acquires a current location of the own vehicle 2 (S100). Subsequently, based on the current location of the own vehicle 2 and map information and to turn, the environment image generating unit 25 generates a virtual environment image that is a virtual image showing a surrounding environment of the own vehicle 2 (S104). The map information may be acquired from, for example, the navigation device 7.

Next, the partial video image extracting unit 26 acquires a real environment video image of a surrounding of the own vehicle 2 from the vehicle-mounted camera 3 and extracts a participant video image that is a video image portion of a traffic participant from the real environment video image (S106). Also, the vehicle detecting unit 27 detects a location of a surrounding vehicle that is a vehicle within the surrounding environment and vehicle attributes including a model, size, and/or color from the real environment video image above (S108). At that time, the vehicle detecting unit 27 may determine the presence of the possibility that the detected surrounding vehicle contacts the own vehicle.

Then, the display control unit 28 generates a composite image by inlaying, into the virtual environment image, a surrounding vehicle indication showing the detected surrounding vehicle and a participant video image of at least the extracted pedestrian at corresponding positions on the virtual environment image (S110) and displays the generated composite image on the display device 12 (S112), and the processing ends.

After the processing ends, the processor 20 returns to step S100 and the processing is repeated where a composite image at the current time is displayed in real time on the display device 12.

It should be noted that, in parallel with this processing, the display control unit 28 can move the position of the center of the point of view for a composite image and/or increase the display magnification of the composite image in response to a touch on a part of the composite image displayed in step S112.

### OTHER EMBODIMENTS

Having described that, according to the aforementioned embodiment, a real environment video image is acquired from the camera 3 mounted in the own vehicle 2, it may be acquired from a street camera existing in a surrounding environment through road-to-vehicle communication or the like.

Also, a real environment video image may be acquired from a vehicle-mounted camera included in a vehicle surrounding the own vehicle 2 through communication over a communication network or vehicle-to-vehicle communication.

Also, having described that, according to the aforementioned embodiment, the display control unit 28 highlights a participant video image of a traffic participant such as a pedestrian and a bicycle, the highlighting may be performed only for pedestrian requiring special attention such as children and elderly people among pedestrians. The highlighting may be blinking or zooming in addition to the aforementioned aspects.

The display control unit 28 can display on the display device 12 a composite image based on a clear virtual environment image independent of an environment condition even when direct visibility is poor such as during nighttime, in the rain or the like.

The camera 3 may be an infrared camera. Thus, the existence of a pedestrian that cannot be recognized by the naked eye in the dark can be conveyed on the composite image to the driver D.

In response to a touch at an arbitrary position on a composite image displayed on the display device 12, the display control unit 28 may generate a composite image by further inlaying a partial video image corresponding to the touched position in the real environment video image into a virtual environment image.

It should be noted that the present invention is not limited to the configurations of the aforementioned embodiments and can be implemented in various aspects without departing from the spirit and scope of the present invention.

### Configurations Supported by the Aforementioned Embodiments

The aforementioned embodiments support the following configurations.

(Configuration 1) A display system including a location acquiring unit that acquires a current location of an own vehicle, an environment image generating unit that generates a virtual environment image based on a current location of the own vehicle and map information, the virtual environment image being a virtual image showing a surrounding environment of the own vehicle, a partial video image extracting unit that acquires a real environment video image of a surrounding of the own vehicle and extracts a participant video image, the participant video image being a video image portion of a traffic participant from the real environment video image, and a display control unit that generates and displays on a display device a composite image by inlaying each of the extracted participant video image into the virtual environment image at a corresponding position on the virtual environment image.

According to the display system of Configuration 1, by using a participant video image inlaid into a virtual environment image, the existence of a traffic participant and the like that should be considered in driving can be conveyed to a driver in a recognizable and realistic aspect by omitting information unnecessary for driving present in the real space and simply displaying necessary information.

(Configuration 2) The display system according to Configuration 1, wherein the display control unit highlights a participant video image of the traffic participant who is a pedestrian in the composite image.

According to the display system of Configuration 2, the existence of a pedestrian that can be easily overlooked by the driver can be conveyed to the driver more securely and realistically.

(Configuration 3) The display system according to Configuration 1 or 2, further including a vehicle detecting unit that detects, from the real environment video image, a location of a surrounding vehicle that is a vehicle within the surrounding environment and a vehicle attribute including a model, a size, and/or color of the surrounding vehicle, wherein, for a traffic participant which is a surrounding vehicle, the display control unit generates the composite image by inlaying a virtual vehicle representation, which is a graphic representation according to a vehicle attribute of the surrounding vehicle, at a corresponding position on the virtual environment image as a surrounding vehicle indication.

According to the display system of Configuration 3, since a virtual vehicle representation is used for displaying of a vehicle with detail information that can be easily represented by using a graphic representation, the processing load required for generation and output of a composite image to a display device can be reduced.

(Configuration 4) The display system according to any one of Configurations 1 to 3, wherein the display device is a touch panel, and, in response to a user's operation on the display device, the display control unit displays the composite image on the display device such that the position designated by the operation is at the center by moving the point of view for the composite image and/or displays the composite image enlarged by a predetermined magnification on the display device.

According to the display system of Configuration 4, the driver can freely change the center position and/or the display magnification of the composite image as needed, allowing to grasp the surrounding environment more easily.

(Configuration 5) The display system according to Configuration 3 or 4, wherein the vehicle detecting unit determines the presence of a possibility that the surrounding vehicle contacts the own vehicle, and when there is a possibility that the surrounding vehicle contacts the own vehicle, the display control unit highlights the surrounding vehicle indication corresponding to the surrounding vehicle on the composite image.

According to the display system of Configuration 5, the existence of a surrounding vehicle having a possibility of a contact or a collision can be conveyed to the driver more securely.

(Configuration 6) The display system according to any one of Configurations 1 to 5, wherein the display control unit generates a composite image based on the virtual environment image and the participant video image at a current time at predetermined time intervals and displays the composite image at the current time in real time on the display device.

According to the display system of Configuration 6, in a traffic environment that changes moment by moment so that an appearance or movement of the traffic participant or participants can be conveyed to the driver in an aspect that facilitates spatial recognition and that makes a traffic participant realistic and conspicuous.

(Configuration 7) The display system according to any one of Configurations 1 to 6, wherein the display device is arranged in front of a pillar on a side having a driver's seat of the own vehicle.

According to the display system of Configuration 7, the driver can acquire information from a composite image displayed on the display device with small movement of line of sight.

(Configuration 8) The display system according to any one of Configurations 1 to 7, wherein the virtual environment image is an image having a bird's eye view of the surrounding environment including a current location of the own vehicle, and a virtual own-vehicle representation, which is a graphic representation indicating the own vehicle, is overlaid at a position corresponding to the own vehicle on the virtual environment image.

According to the display system of Configuration 8, since a virtual environmental image from a bird's eye view of surroundings of the current location of the own vehicle including a virtual own-vehicle representation indicating the own vehicle is used as the base, the driver can easily grasp a positional relationship between a traffic participant and the own vehicle and a positional relationship between traffic participants, compared to a bird's eye view combining a plurality of camera images by which a video image is easily distorted.

(Configuration 9) A display method executed by a computer included in a display system, the method including the steps of acquiring a current location of an own vehicle, generating a virtual environment image based on a current location of the own vehicle and map information, the virtual environment image being a virtual image showing a surrounding environment of the own vehicle, acquiring a real environment video image of a surrounding of the own vehicle and extracting a participant video image, the participant video image being a video image portion of a traffic participant from the real environment video image, and generating and displaying on a display device a composite image by inlaying each of the extracted participant video image into the virtual environment image at a corresponding position on the virtual environment image.

According to the display method of Configuration 9, since a video image of a traffic participant is inlaid into a virtual environment image while allowing for easy grasp of a three-dimensional positional relationship of a traffic environment including a traffic participant based on a virtual environment image, the existence of the traffic participant and details of its movement can be conveyed to the driver realistically.
1: display system, 2: own vehicle, 3: camera, 3a: front camera, 3b: left lateral camera, 3c: right lateral camera, 4: object detection device, 5: vehicle monitoring device, 6: GNSS receiver, 7: navigation device, 10: driver's seat, 11, 11a, 11b: pillar, 12, 14: display device, 13: instrument panel, 20: processor, 21: memory, 22: display program, 23: location acquiring unit, 25: environment image generating unit, 26: partial video image extracting unit, 27: vehicle detecting unit, 28: display control unit, 30, 30a, 30b, 30c, 30d: composite image, 31: virtual environment image, 32: virtual own-vehicle representation, 33: participant video image, 34: surrounding vehicle indication, D: driver, P1, P2: position

What is claimed is:

1. A display system comprising a processor, wherein the processor includes:
a location acquiring unit that acquires a current location of an own vehicle;
an environment image generating unit that generates a virtual environment image based on a current location of the own vehicle and map information, the virtual environmental image being a virtual image showing a surrounding environment of the own vehicle;
a partial video image extracting unit that acquires a real environment video image of a surrounding of the own vehicle and extracts a participant video image, the participant video image being a video image portion of a traffic participant from the real environment video image; and
a display control unit that generates and displays on a display device a composite image by inlaying each of the extracted participant video image into the virtual environment image at a corresponding position on the virtual environment image.

2. The display system according to claim 1,
wherein the display control unit highlights a participant video image of the traffic participant who is a pedestrian in the composite image.

3. The display system according to claim 1, wherein the processor further comprising a vehicle detecting unit that detects, from the real environment video image, a location of a surrounding vehicle that is a vehicle within the surrounding environment and a vehicle attribute including a model, a size, and/or color of the surrounding vehicle,
wherein, for a traffic participant which is a surrounding vehicle, the display control unit generates the composite image by inlaying a virtual vehicle representation, which is a graphic representation according to a vehicle attribute of the surrounding vehicle, at a corresponding position on the virtual environment image as a surrounding vehicle indication.

4. The display system according to claim 1,
wherein the display device is a touch panel, and
wherein, in response to a user's operation on the display device, the display control unit
displays the composite image on the display device such that a position designated by the operation is at the center by moving the point of view for the composite image and/or
displays the composite image enlarged by a predetermined magnification on the display device.

5. The display system according to claim 3,
wherein the vehicle detecting unit determines the presence of a possibility that the surrounding vehicle contacts the own vehicle; and
wherein, when there is a possibility that the surrounding vehicle contacts the own vehicle, the display control unit highlights the surrounding vehicle indication corresponding to the surrounding vehicle on the composite image.

6. The display system according to claim 1,
wherein the display control unit generates a composite image based on the virtual environment image and the participant video image at a current time at predetermined time intervals and displays the composite image at the current time in real time on the display device.

7. The display system according to claim 1,
wherein the display device is arranged in front of a pillar on a side having a driver's seat of the own vehicle.

8. The display system according to claim 1,
wherein the virtual environment image is an image having a bird's eye view of the surrounding environment including a current location of the own vehicle, and a virtual own-vehicle representation, which is a graphic representation indicating the own vehicle, is overlaid at a position corresponding to the own vehicle on the virtual environment image.

9. A display method executed by a computer included in a display system, the method comprising the steps of:
acquiring a current location of an own vehicle;
generating a virtual environmental image based on a current location of the own vehicle and map information, the virtual environmental image being a virtual image showing a surrounding environment of the own vehicle;
acquiring a real environment video image of a surrounding of the own vehicle and extracting a participant video image, the participant video image being a video image portion of a traffic participant from the real environment video image; and
generating and displaying on a display device a composite image by inlaying each of the extracted participant video image into the virtual environmental image at a corresponding position on the virtual environmental image.
